(19) United States
(12) Patent Application Publication
(10) Pub. No.: US 2007/0017743 A1
(43) Pub. Date: Jan. 25, 2007

(54) Up and down movement step assembly for a vehicle

(75) Inventor: Peter Yeh, Tainan Hsien (TW)

Correspondence Address: Troxell Law Office PLLC, Suite 1404, 5205 Leesburg Pike, Falls Church, VA, 22041, US

(73) Assignees: Many Wain Enterprise Co., Ltd.; Modas Shing Company Ltd.

(21) Appl. No.: 11/184,972

(22) Filed: Jul. 20, 2005

(51) Int. Cl. E06C 5/00

(52) U.S. Cl. 182/127

(57) ABSTRACT

A step assembly for a vehicle includes a base, a driving gear firmly connected to the shaft of the reduction device so as to be driven by the reduction device, two driven gears respectively and rotatably connected to the inner side of the base, an arm assembly pivotally provided to each of the two driven gears and a step securely and firmly connected to the arm assembly to be moved linearly.

### BACKGROUND OF THE INVENTION

1. Field of the Invention

The present invention relates to a step assembly, and more particularly to a step assembly to help people getting on/off a vehicle.

2. Description of Related Art

A large vehicle normally has a step assembly provided to a side of the vehicle to help people getting on/off the vehicle. A conventional step assembly is affixed to the side of the vehicle body and is immovable relative to the vehicle body so that the vehicle body width is eventually wider than its original width. Also the distance from the vehicle body to the ground is reduced when the step assembly extends downward from the vehicle body. Therefore, the conventional step assembly has more disadvantages than advantages it brings to the vehicle.

In order to overcome the shortcomings, an improved step assembly is shown in FIG. 6 and affixed to a base (60) on a vehicle. The base (60) has a driving device (61) composed of a server motor (611), two arms i.e., a first arm (62) and a second arm (63), and a step (64) firmly connected to distal ends of both the first arm (62) and the second arm (63).

The server motor (611) has a driving shaft (612) extending through the first arm (62) and into the base (60). The second arm (63) is pivotally connected to a side face of the base (60). Therefore, when the server motor (611) is actuated, the server motor (611) is able to drive the first arm (62) to pivot toward/away from the server motor (611) such that the step (64) is then swung back and forth with the assistance of the second arm (63).

The structure of this assembly does solve the aforementioned shortcomings concerning a low and wide vehicle body, but engineering problems still bother the users in that a torque from the server motor (611) to the driving shaft (612) is far less than the torque from the driving shaft (612) to the step (64), which means the server motor (611) has to provide a much larger force than actually required so as to pivot the step (64). Furthermore, in regards to the structure, the step (64) is only held by the first arm (62) and the only function the second arm (63) provides to the step (64) is to balance it. Furthermore, it is found that the step (64) gradually loosens from the step due to vibration and rocking of the vehicle.

To overcome the shortcomings, the present invention tends to provide an improved step assembly to mitigate the aforementioned problems.

### SUMMARY OF THE INVENTION

The primary objective of the present invention is to provide an improved step assembly having two arms respectively and pivotally connected to a step so that the step is horizontally held by both of the arms.

In one aspect of the present invention, the step assembly of the present invention is provided with a driving gear and two driven gears directly and indirectly mated with the driving gear so that the driving gear is able to drive the two driven gears to rotate. Each of the two driven gears has a gear shaft extending from a center of the corresponding driven gear to connect to corresponding proximal ends of the two arms such that the actuation of the driving gear is able to lift the step via the two arms.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the step assembly of the present invention;

FIG. 2 is a perspective view of the step assembly from a different angle relative to FIG. 1;

FIG. 3 is a schematic side plan view showing the relationships among components;

FIG. 4 is a schematic view showing that the two arms are pivoted to retract the step due to the driving of the driving gear;

FIG. 5 is a schematic view showing that the step is lowered from the actuation of the driving gear; and

FIG. 6 is a perspective view of a conventional step assembly.

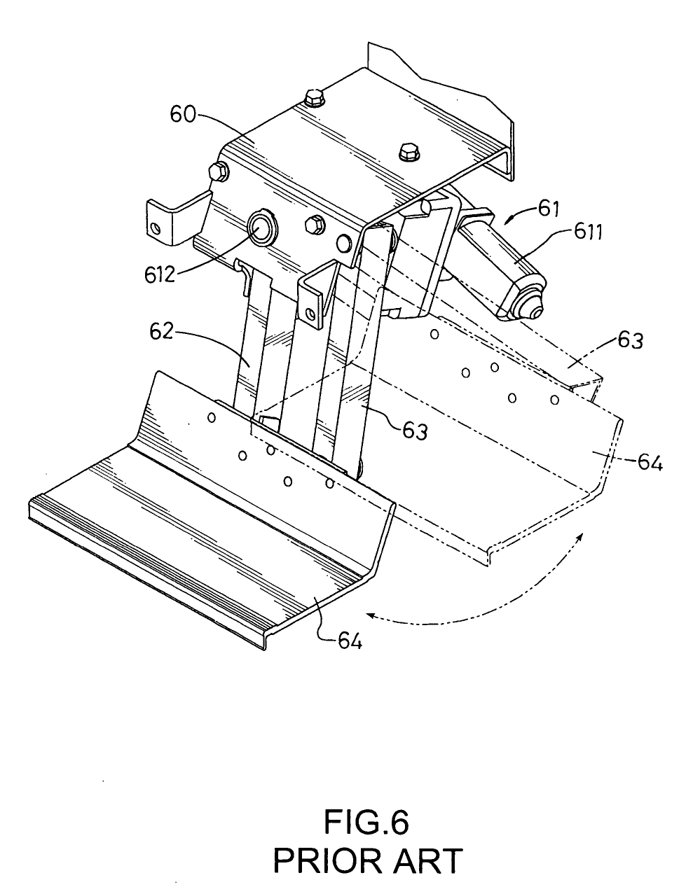

### DETAILED DESCRIPTION OF THE PREFERRED EMBODIMENT

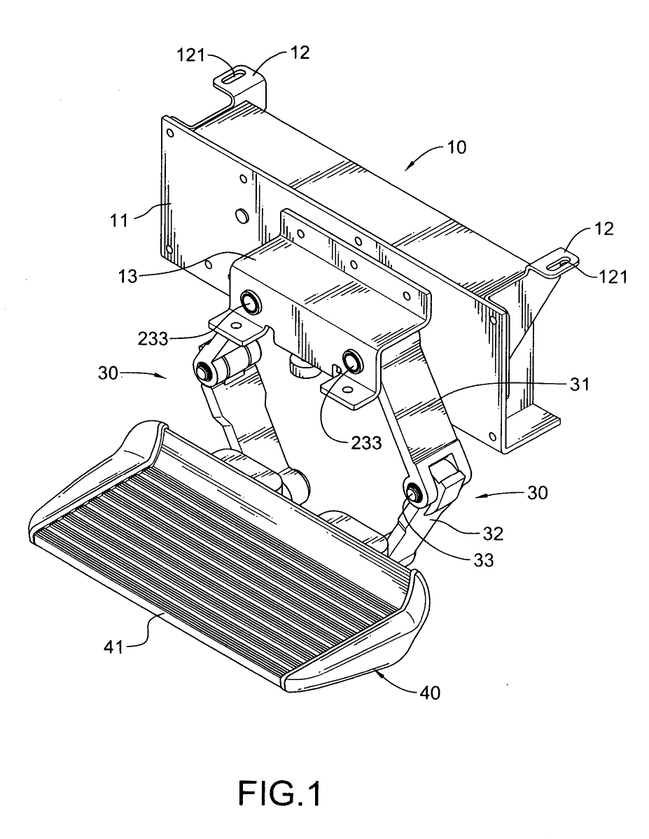

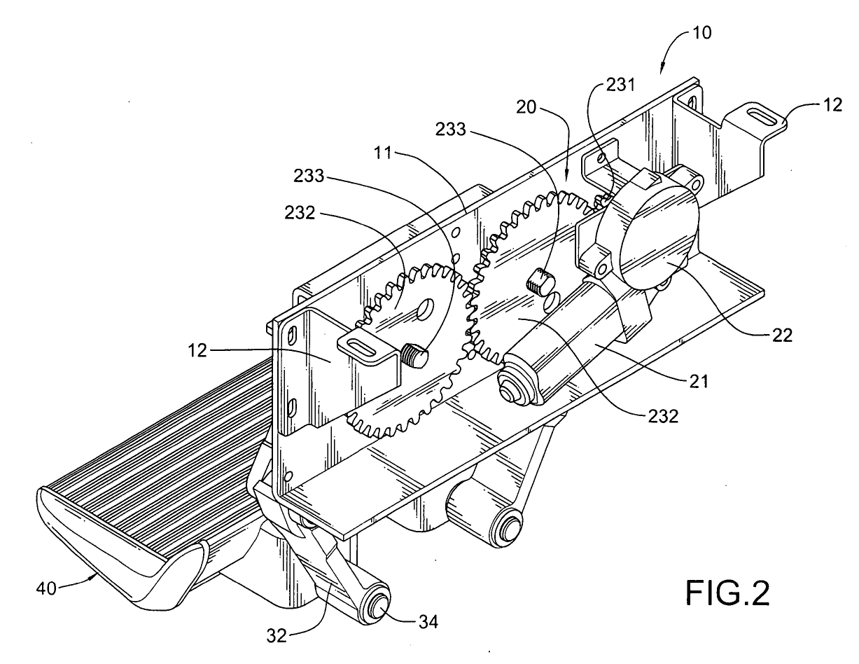

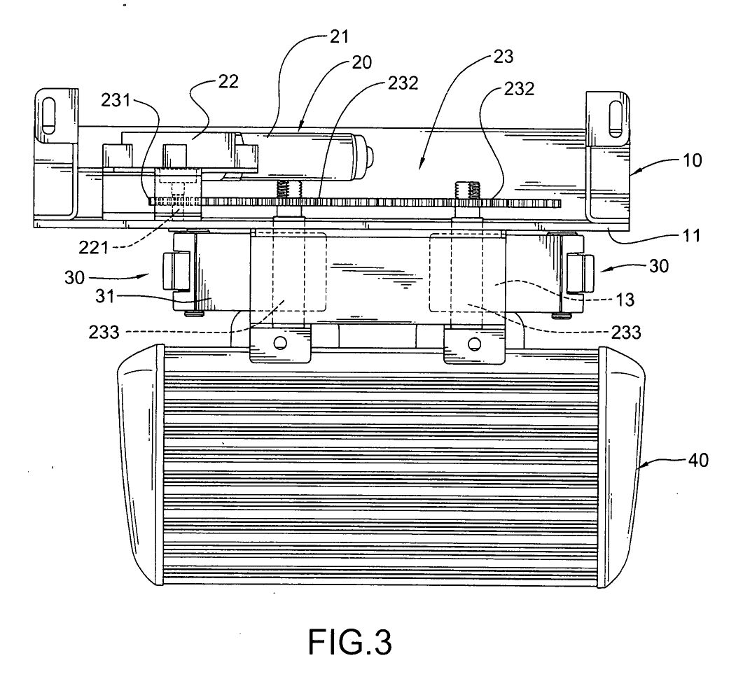

With reference to FIGS. 1, 2 and 3, it is noted that the step assembly in accordance with the present invention includes a base (10) having a front panel (11) and two connecting walls (12) formed on opposed sides of the front panel (11) and respectively having a connecting hole (121) defined in a ledge formed on a top portion of the connecting wall (12). A bracket(13) is affixed to aside face of the front panel (11). A driving device (20) is provided behind the front panel (11) and includes a server motor (21) mounted on a rear side face of the front panel (11), a reduction device (22) operably connected to the server motor (21) and having a shaft (221) extending out therefrom to connect to a gear assembly (23). The gear assembly (23) includes a driving gear (231) operably connected to the shaft (221) and two driven gears (232) operably mated to each other and with the driving gear (231). Each of the two driven gears (232) has a pivot shaft (233) firmly extending from a center of a corresponding one of the driven gears (232) and out of a side face of the bracket (13).

An arm assembly (30) is provided to each of the two pivot shafts (233) and includes a first arm (31) directly and firmly engaged with a corresponding one of the two pivot shafts (233) and a second arm (32) pivotally connected to a distal end of the first arm (31) via a pivot (33). Both first arms (31) and both second arms (32) are correlated to each other such that the first arms (31) are oblique to each other and the second arms (32) are also oblique to each other.

A step (40) is then firmly connected to free ends of both of the second arms (32) and provided with a pattern (41) formed thereon to provide a slip-proof function.

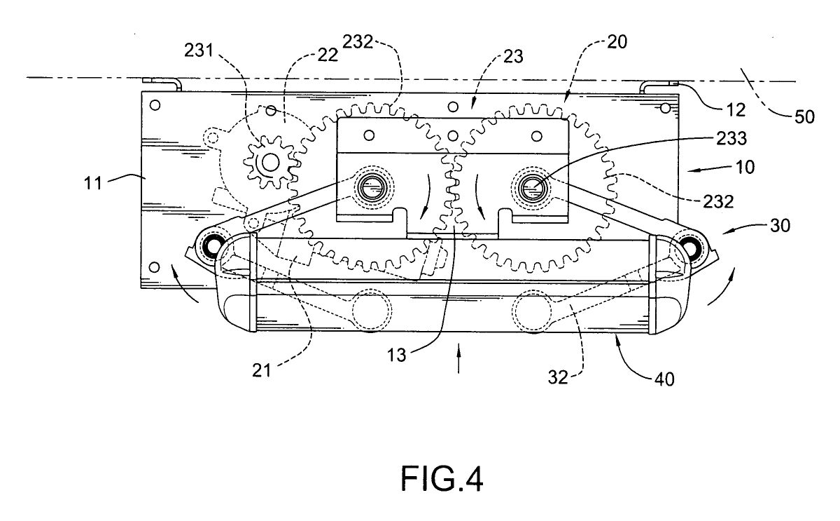

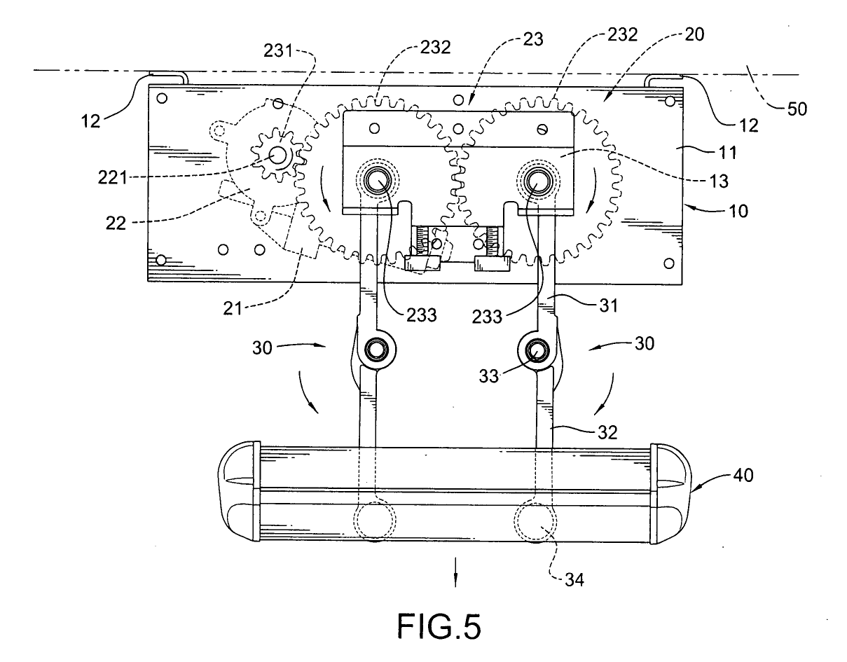

With reference to FIGS. 4 and 5 and still taking FIG. 1 for reference, the base (10) is first connected to the hull of a vehicle by the assistance of means such as screws, bolts or the like extending through the connecting holes (121) to mount the base (10) on a side of the hull. Thereafter, when the server motor (21) is actuated, the driving gear (231) is also actuated by the assistance of the reduction device (22). Then both the driven gears (232) are driven to rotate in two different directions. Because the two pivot shafts (233) are firmly and respectively connected to the two driven gears (232), the two pivot shafts (233) are also rotated. The rotation of the two pivot shafts (233) drives the two first arms (31) as well as the second arms (32) to pivot, which retracts or extends the step (40) and accomplishes the goal of moving the step (40) up and down relative to the base (10).

In conclusion, it is found that the present invention has the following advantages:

1. Low motor load

The torque from the reduction device (22) to the pivot shaft (233) is much larger than the torque from the pivot shaft (233) to the step (40) such that work of the server motor (21) is little to lift the step (40).

2. Due to the dual arm connection to the step (40), the step is not easily rocked while the vehicle is moving.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A step assembly for a vehicle, the step assembly comprising:
a base adapted to be firmly connected to a side of the vehicle and having a bracket formed on a front face of the base;
a server motor securely connected to an inner side of the base;
a reduction device operably connected to the server motor to be driven by the server motor and having a shaft extending out therefrom;
a driving gear firmly connected to the shaft of the reduction device so as to be driven by the reduction device;
two driven gears respectively and rotatably connected to the inner side of the base, the two driven gears being mated to each other and operably connected to the driving gear, each driven gear being rotated in a direction different from the other driven gear;
an arm assembly pivotally provided to each of the two driven gears; and
a step securely and firmly connected to the arm assembly to be moved linearly.

2. The step assembly as claimed in claim 1, wherein the arm assembly comprises two first arms respectively and pivotally connected to a corresponding one of the two driven gears and two second arms respectively and pivotally connected to a distal end of a corresponding one of the two first arms so that the step is able to be moved up and down when the server motor is actuated.

3. The step assembly as claimed in claim 2, wherein each of the two driven gears is firmly connected to the corresponding first arm via a pivot shaft firmly connected to a corresponding one of the two driven gears and extending out of the front face of the base.
